(19) United States
(12) Patent Application Publication
(10) Pub. No.: US 2008/0157568 A1
(43) Pub. Date: Jul. 3, 2008

(54) Automobile compact disc headliner

(76) Inventor: David S. May, Claymont, DE (US)

Correspondence Address: David S. May Jr, 7322 Society Dr, Claymont, DE, 19703, US

(21) Appl. No.: 11/648,728

(22) Filed: Jan. 3, 2007

(51) Int. Cl. B60J 9/00

(52) U.S. Cl. 296/214

(57) ABSTRACT

An automobile headliner assembly for motor vehicles is adapted to store a plurality of compact discs. Located directly above the vehicles sun visor on both the passenger and driver side is an assembly including an outer fabric cover. The outer fabric cover includes an upper fabric member having a continuous length. The upper fabric member is folded over itself to define a plurality of shingled pockets. Each pocket includes an opening for receiving one of the pluralities of compact discs.

### BACKGROUND OF THE INVENTION

This invention relates to storing compact discs inside automobiles. With compact disc players and DVD players becoming more and more standard in the automobile industry, this will eventually become a concern to the consumer driving the vehicle. There hasn't been many devices geared to ensuring there are places to store your compact discs while you are traveling in your vehicle. There's the compact disc visor that attaches to the sun visor in your vehicle which gives you quick and easy access to your compact discs by just pivoting down your sun visor. There are also the compact disc wallets, which is designed like a book with felt sleeves being the pages enabling you to store your compact discs accordingly. Many automobiles now come with compartments to store compact discs in effort to accommodate the driver. These options are all valuable ways of storing your compact discs while operating your vehicle but they also have some disadvantages. The compact disc visor is probably the best option of them all because of its quick and easy access. However, if your vehicle comes equipped with a vanity mirror it would be extremely difficult if not impossible to use your vanity mirror with your compact disc visor attached to your sun visor. Compact disc visors can also be somewhat unattractive. A compact disc wallet is a bit more inconvenient to the driver because the driver must first locate the wallet, open the wallet, eject the current disc out of the compact disc player, take out the disc he/she would like to use from the wallet, load the compact disc into the compact disc player, return the disc he was using to the wallet, close the wallet, and return the wallet to its original position. This can be uncomfortable, inconvenient, and dangerous all at once. The compartments that are now becoming standard with automobiles incorporate pretty much the same concept as the compact disc wallet. They also have the same disadvantages as the compact disc wallet. The only difference is instead of the compact discs being housed without the jewel case as with the compact disc wallet, the automobile compartments allow you to keep the compact discs in there original cases for access later which pose the same access regiment as the compact disc wallet. Last but not least, you have the option of purchasing a vehicle with a compact disc changer already installed. This ensures not having to worry about storing the compact discs because they are currently housed inside the compact disc changer. The disadvantage though, is that there aren't too many vehicles that have this feature and if they do they are probably expensive. Also, if the compact disc changer jams, the vehicles stereo tends to malfunction as well.

### SUMMARY OF THE INVENTION

The automobile compact disc headliner is a unique device that allows the storage of compact disc directly into the automobiles headliner. This is accomplished by a plurality of compact disc pockets being manufactured directly above the vehicles sun visors. It is very simple to use and is very convenient for the driver while driving. The compact disc headliner solves many of the problems that exist when using other vehicle compact disc storage devices. The compact disc headliner does not interfere with the vehicles vanity mirror as does the compact disc visor and is very attractive as it blends in with the interior of the vehicle. It is very accessible and within the drivers reach as opposed to the driver having to find the compact disc wallet or automobile compartment and proceed to go through the process of loading and unloading the compact disc he/she would like to use. There are also more options to store compact discs in the compact disc headliner than it would be in the compact disc wallets or automobile compartments. There would be no worry about the compact disc headliner jamming or being too expensive as it is embedded into the automobile headliner that comes standard with the vehicle which makes it inexpensive. Also, the compact disc pockets are strategically configured to make it easy to maneuver the compact discs in and out of the headliner.

### BRIEF DESCRIPTION OF THE DRAWINGS

FIG. 1 illustrates the interior of the vehicle and displays where compact discs are stored in the headliner. Notice the sun visors of the vehicle are not covered and both the passenger and the driver are able to access them. The compact disc pockets are located directly atop of the vehicles sun visors.

### DESCRIPTION OF THE SPECIFIC EMBODIMENTS

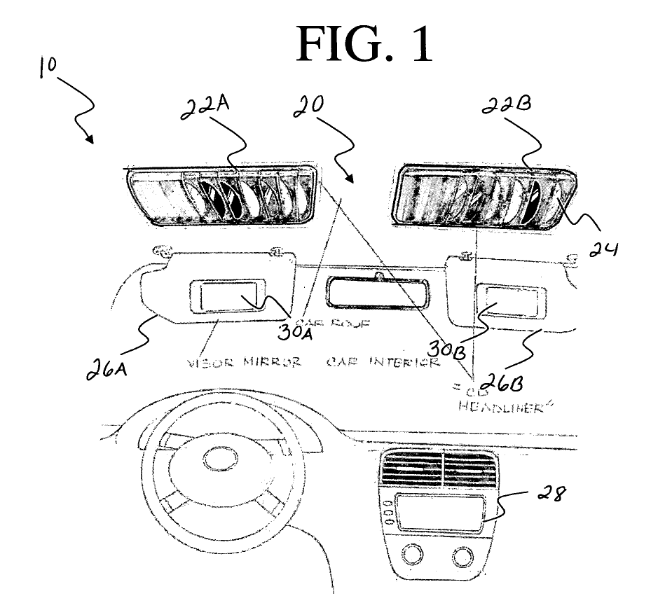

As seen in FIG. 1, the compact disc pockets 22 are installed into the headliner 20 and located directly above the sun visors 26 on the passenger and on the drivers' side. If the driver or passenger wishes to access a compact disc 24 they would simply eject the compact disc 24 already in the compact disc player 28, flip down the sun visor 26 to expose the compact disc pockets 22, store the compact disc in one of the pockets, and replace it with the desired compact disc 24 they would like to use by pulling one of the compact discs 24 out of the pockets 22 and then putting it in the compact disc player 28. This system is quick, safe and convenient for the driver. As you can see in FIG. 1 the sun visors 26 are easily accessible along with the vanity mirrors 30.

What is claimed:

1. An automobile headliner assembly for motor vehicles adapted to store a plurality of compact disc media directly into the vehicle headliner. Embedded into the vehicle headliner will be organizing holding apparatus' for compact disc media where compact disc media can be safely stored and retrieved by the passengers of the vehicle at any time.
